(19) United States
(12) Patent Application Publication
(10) Pub. No.: US 2020/0142207 A1
(43) Pub. Date: May 7, 2020

(54) THREE-DIMENSIONAL IMAGE DISPLAY APPARATUS

(71) Applicant: SILICON TOUCH TECHNOLOGY INC., Hsinchu (TW)

(72) Inventor: CHI-YUAN CHIN, HSINCHU (TW)

(21) Appl. No.: 16/672,598

(22) Filed: Nov. 4, 2019

(30) Foreign Application Priority Data
Nov. 7, 2018 (TW) 107139522

(51) Int. Cl. G02B 27/22; H04N 13/32; H04N 13/393

(52) U.S. Cl. CPC G02B 27/2285; H04N 13/393; H04N 13/32

(57) ABSTRACT

A three-dimensional image display apparatus is provided. The three-dimensional image display apparatus includes an image display module and a processing module electrically connected to the image display module. The image display module includes a plurality of three-dimensional display assemblies each including a pixel display unit for outputting an optical signal and a variable focus lens unit which is disposed on the pixel display unit and configured to allow the optical signals to pass therethrough and be focused on a focal position thereof. The processing module controls the optical signal of each pixel display unit and the focal position of each variable focus lens unit according to an imaging information upon receiving a command for periodically displaying a plurality of image blocks corresponding to a three-dimensional image during a time duration. The displaying cycle is not longer than the response time of visual persistence of human eyes.

### CROSS-REFERENCE TO RELATED PATENT APPLICATION

This application claims the benefit of priority to Taiwan Patent Application No. 107139522, filed on Nov. 7, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a three-dimensional (3D) image display apparatus, and more particularly to a volumetric three-dimensional image display apparatus.

### BACKGROUND OF THE DISCLOSURE

In conventional stereoscopic display technologies, the binocular parallax of human eyes is utilized to generate stereoscopic effects. Specifically, different images can be respectively received by the left eye and the right eye of a viewer and be analyzed and overlapped by the human brain, thereby allowing the viewer to have a depth perception, and hence, perceive an image in three dimensions.

The conventional three-dimensional stereoscopic display technologies can generally be categorized into stereoscopic display technology (with the use of headgears or glasses) and auto-stereoscopic display technology (which is glasses-free). Auto-stereoscopic display technologies that are widely used include parallax barrier type auto-stereoscopic technology and lenticular lens type auto-stereoscopic technology, and the principle thereof is disposing a plurality of barriers or lens apparatus in front of a display to allow different displayed images represented by adjacent pixels on the display to be respectively transmitted to the left eye and the right eye of the viewer through the barrier or the lens, thereby generating a stereoscopic effect.

However, the angle of view for most auto-stereoscopic displays is limited, i.e., the viewer must be located at a specific position with specific distance to experience a more ideal stereoscopic effect. Therefore, the conventional auto-stereoscopic display is not likely to be applied to circumstances with multiple viewers or multiple angles of view.

### SUMMARY OF THE DISCLOSURE

In response to the above-referenced technical inadequacies, the present disclosure provides a three-dimensional image display apparatus with less angle of view limitation that enables the viewer(s) to experience stereoscopic effect at different positions without the use of glasses.

In one aspect, the present disclosure provides a three-dimensional image display apparatus including an image display module and a processing module electrically connected to the image display module. The image display module includes a plurality of three-dimensional display assemblies each including a pixel display unit for outputting an optical signal and a variable focus lens unit. The variable focus lens unit is disposed on the pixel display unit, and the optical signal passes through the variable focus lens unit and is projected to a focal position of the variable focus lens unit. When the processing module receives a command, the processing module controls the optical signal outputted by each of the pixel display units and adjusts a focal length of each of the variable focus lens units according to an imaging information for periodically displaying a plurality of image blocks corresponding to a three-dimensional image during a time duration, and a displaying cycle of displaying the plurality of image blocks is not longer than a response time of visual persistence of human eyes.

Therefore, one of the advantages of the present disclosure is that the three-dimensional image display apparatus provided by the present disclosure can generate a stereoscopic image that is suitable for multiple viewers positioned at different angles of view by the technical features of “controlling the optical signal outputted by each of the pixel display units and adjusting a focal length of each of the variable focus lens units for periodically displaying a plurality of image blocks corresponding to a three-dimensional image during a time duration, and a displaying cycle of displaying the plurality of image blocks is no longer than a response time of visual persistence of human eyes.”

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a functional block diagram of a three-dimensional display apparatus according to an embodiment of the present disclosure.

FIG. 2 is a perspective schematic view of an image display module according to an embodiment of the present disclosure.

FIG. 3 shows a displaying cycle of a plurality of image blocks according to an embodiment of the present disclosure.

FIG. 4 is a functional block diagram of a three-dimensional display apparatus according to another embodiment of the present disclosure.

FIG. 5 is a perspective schematic view showing the cooperation of the image display module and the driving member according to another embodiment of the present disclosure.

FIG. 6 is a perspective schematic view showing the cooperation of the image display module and the driving member according to yet another embodiment of the present disclosure.

FIG. 7 is a perspective schematic view showing the cooperation of the image display module and the driving member according to a further embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

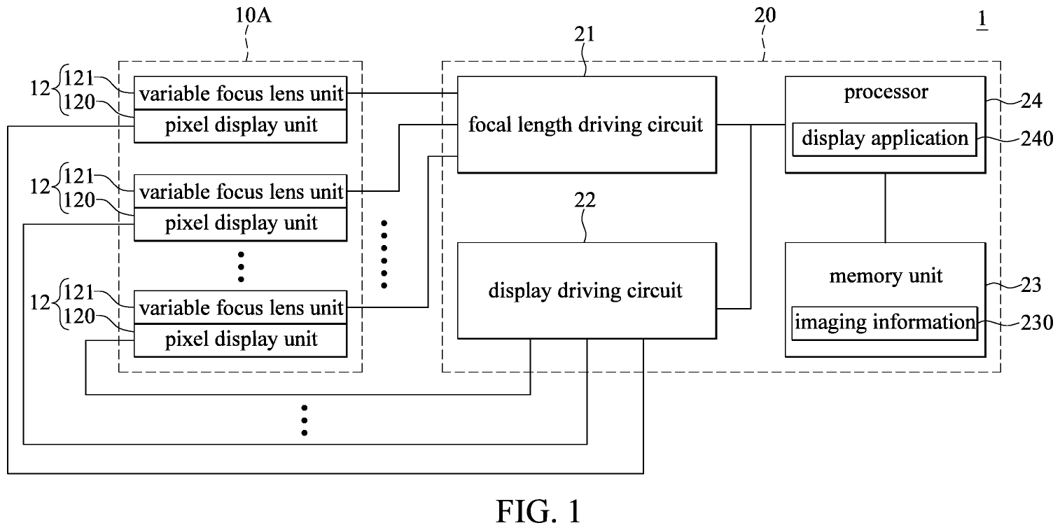

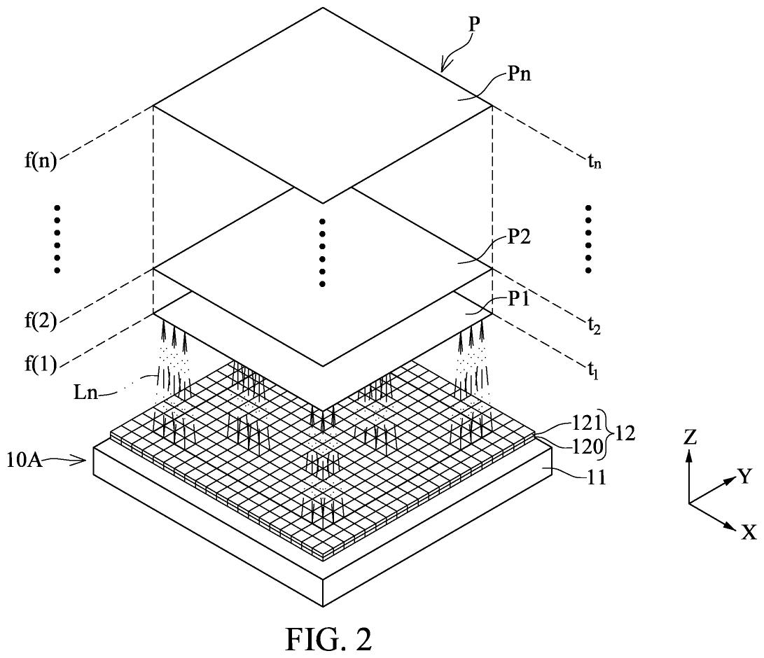

Reference is made to FIG. 1 and FIG. 2, which respectively show a functional block diagram of a three-dimensional display apparatus according to an embodiment of the present disclosure and a perspective schematic view of an image display module according to an embodiment of the present disclosure.

The three-dimensional image display apparatus 1 of the embodiments of the present disclosure includes an image display module 10A and a processing module 20 electrically connected to the image display module 10A.

Referring to FIG. 2, in the present embodiment, the image display module 10A includes a substrate 11 and a plurality of three-dimensional display assemblies 12 disposed on the substrate 11. In the present embodiment, the three-dimensional display assemblies 12 are arranged on the substrate 11 into a two-dimensional array. In addition, each of the three-dimensional display assemblies 12 includes a pixel display unit 12 and a variable focus lens unit 121.

Each of the pixel display units 120 is configured to output an optical signal Ln. In an embodiment, each of the pixel display units 120 includes at least a light-emitting member such as a light-emitting diode for outputting a light beam, and the light beam can be a monochromatic light beam or a multi-chromatic light beam.

In another embodiment, a pixel display unit 120 can include three light-emitting members for generating different color of lights respectively, such as a red light-emitting diode, a blue light-emitting diode and a green light-emitting diode, to generate a plurality of colors of lights with different hues, lightness and saturation. Therefore, the hue, the lightness or the saturation of the optical signal Ln can be changed by adjusting a display driving signal of each of the pixel display units 120. The display driving signal can be a current value or a voltage value applied to the pixel display unit 120.

As shown in FIG. 2, the plurality of variable focus lens units 121 is respectively disposed on the plurality of pixel display units 120 for projecting the optical signals Ln outputted by the pixel display units 120 at a predetermined position in a three-dimensional space.

Specifically, the variable focus lens units 121 can each be an electrically tunable focusing lens, a liquid crystal lens, an elasto-metic membrane lens, an electrowetting lens or a dielectrophoretic lens.

In the present embodiment, each of the variable focus lens units 121 is a liquid crystal lens. When a voltage applied to the liquid crystal lens is changed, the refractive index of the liquid crystal molecules of the liquid crystal lens is changed accordingly and hence, the focal length of the liquid crystal lens is changed. When the liquid crystal lens is subjected to different voltages under different time points, the focal length thereof varies with the change of the voltage under those different time points.

Therefore, the focal length of each of the variable focus lens units 121 may have a maximum value and a minimum value. In addition, the focal position of a variable focus lens unit 121 may vary along an optical axis based on the change of the focal length of the variable focus lens unit 121. When the focal length of the variable focus lens unit 121 has the maximum value, the variable focus lens unit 121 has a farthest focus position which is most remote from the substrate 11. When the focal length of the variable focus lens unit 121 has the minimum value, the variable focus lens unit 121 has a closest focus position which is nearest to the substrate.

In addition, for the purpose of illustration, the plurality of three-dimensional display assemblies 12 is arranged on the X-Y plane into a two-dimensional array in the present embodiment. In other words, the plurality of three-dimensional display assemblies 12 is arranged into a plurality of rows along the X direction and is arranged into a plurality of columns along the Y direction. In addition, the optical axis of each of the variable focus lens units 121 is parallel to the Z direction. Therefore, the optical signals Ln can be projected into the three-dimensional space by the cooperation of the plurality of pixel display units 120 positioned at different positions and the plurality of variable focus lens units 121 respectively corresponding thereto.

From another aspect, the optical signals Ln outputted by the pixel display units 120 can pass through the corresponding variable focus lens units 121 and be projected on a focus position of the variable focus lens units 121. The focus position is positioned at the optical axis of the variable focus lens unit 121.

Therefore, the position where the optical signal Ln of each of the pixel display units 120 is projected at in the three-dimensional space is between the most remote focus position and the nearest focus position of the corresponding variable focus lens unit 121. In other words, the range of projection of the optical signal Ln of each of the pixel display units 121 is on the optical axis and within the range defined by the most remote focus position and the nearest focus position of the variable focus lens units 121.

Referring to FIG. 1, the processing module 20 includes a focal length driving circuit 21, a display driving circuit 22, a memory unit 23 and a processor 24. The processor 24 is electrically connected to the focal length driving circuit 21, the display driving circuit 22 and the memory unit 23.

The focal length driving circuit 21 is electrically connected to the variable focus lens unit 121 of each of the three-dimensional display assemblies 12. The focal length driving circuit 21 can output a focal length driving signal to each of the variable focus lens units 121 for individually controlling the focal length of each of the variable focus lens units 121. In addition, the focal length driving circuit 21 can be controlled by the processor 24 to output a plurality of focal length driving signals which are same as or different to a plurality of the variable focus lens units 121 respectively in a predetermined order.

The display driving circuit 22 is electrically connected to the pixel display unit 120 of each of the three-dimensional display assemblies 12. Similar to the focal length driving circuit 21, the display driving circuit 22 can output a display driving signal to each of the pixel display units 120 for individually controlling the optical signal Ln generated by each of the pixel display units 120. The display driving signal can be, for example, a current signal.

The hue, value and degree of saturation of the optical signal Ln outputted by the pixel display unit 120 is related to the received display driving signal. Therefore, the optical signals Ln generated by the pixel display units 120, specifically the hues, values and degrees of saturation of the optical signals Ln, can be changed by changing the display driving signals outputted to the pixel display units 120. In addition, the display driving circuit 22 can be controlled by the processor 24 to output a plurality of display driving signals to a plurality of pixel display units 120 respectively in a predetermined order.

The processor 24 can include, but is not limited to including, a programmable controller, a micro-controller, a read-only memory and a random access memory, and can be used to execute at least a display application 240 that is built therein. In an embodiment, the processor 24 can receive an instruction from a user through an input interface (not shown) for executing the display application 240.

Based on the display application 240, the processor 24 can control the display driving circuit 22 to output a predetermined display driving signal to each of the pixel display units 120, and control the focal length driving circuit 21 to output a predetermined focal length driving signal to each of the variable focus lens units 121. Therefore, the processing module 20 can control each of the three-dimensional display assemblies 12 for generating specific optical signals Ln at predetermined positions in the three-dimensional space, thereby displaying a two-dimensional image or a three-dimensional image.

As shown in FIG. 2, the processing module 20 can control the plurality of three-dimensional display assemblies 12 positioned at different positions to generate a plurality of optical signals Ln in the three-dimensional space at the same time point (such as time point t₁), thereby generating an image block P₁ constituted by these optical signals Ln in the space.

It should be noted that in the present embodiment, the three-dimensional image P is divided into a plurality of image blocks P₁˜Pₙ along the optical axis of the variable focus lens. Each of the image blocks Pₙ corresponds to a focal length f(n) of the variable focus lens unit 121.

Specifically, in the present embodiment, at time point t₁, the processor 24 can control the variable focus lens unit 121 in each of the three-dimensional display assemblies 12 for displaying the image block P₁ through the focal length driving circuit 21, such that the plurality of variable focus lens units 121 have same focal length f(1).

At the same time (at time point t₁), the processor 24 can control the pixel display unit 120 in each of the three-dimensional display assemblies 12 through the display driving circuit 22 to output a plurality of optical signals Ln at different positions, and these optical signals Ln correspond to a plurality of parts of the image block P₁ respectively. Therefore, different parts of the image block P1 can have different hues, lightness and saturation according to the three-dimensional image to be displayed.

Similarly, at the next time point t₂, the processor 24 can control the variable focus lens unit 121 in each of the three-dimensional display assemblies 12 that are used to display the image block P₂ through the focal length driving circuit 21, such that the plurality of variable focus lens units 121 have the same focal length f(2). At the same time (time point t₂), the processor 24 can control the pixel display unit 120 in each of the three-dimensional display assemblies 12 through the display driving circuit 22 to output a plurality of optical signals Ln at different positions, and these optical signals Ln correspond to a plurality of parts of the image block P₂ respectively.

In other words, when the processing module 20 controls the plurality of three-dimensional display assemblies 12 to continuously switch for periodically displaying a plurality of different image blocks P₁˜Pₙ at different time points t₁˜tₙ respectively, the viewer can observe the three-dimensional image P constituted by these image blocks P₁˜Pₙ based on the persistence of vision of human eyes.

In the present embodiment, an imaging information 230 corresponding to the three-dimensional image P is stored in the memory unit 23 of the processing module 20. The imaging information 230 can include the focal length f(n) corresponding to each of the image blocks and the plurality of optical signals Ln corresponding thereto. In addition, the imaging information 230 can include the display order, number of cycles and displaying cycle of the plurality of image blocks P₁˜Pₙ, and the display time of each of the image blocks Pₙ.

Therefore, when a command is received by the processing module 20 via an input interface, the processing module 20 can retrieve the imaging information 230 and execute the display application 240 for controlling the optical signal Ln of each of the pixel display units 120 and the focal length of each of the variable focus lens units 121, thereby periodically displaying the plurality of image blocks P₁˜Pₙ corresponding to the three-dimensional image P.

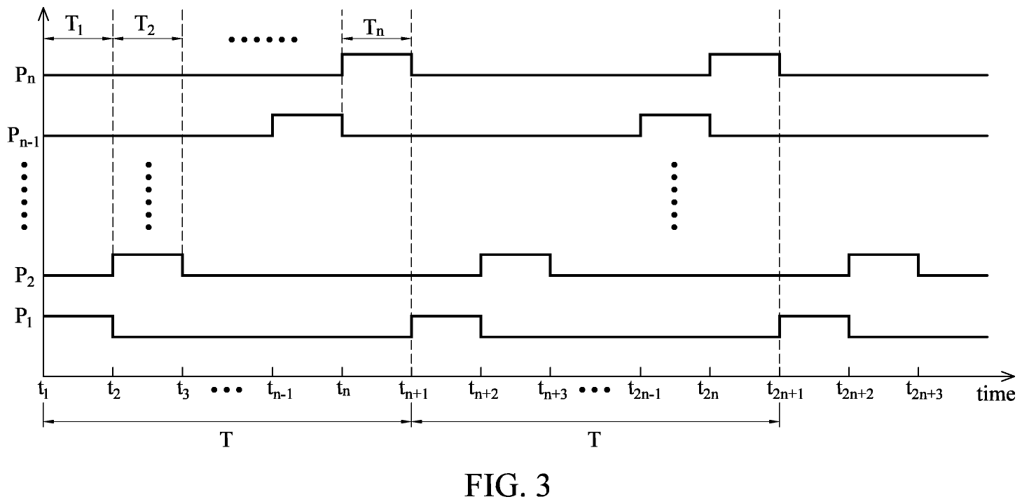

Reference is made to FIG. 3, which shows a displaying cycle of a plurality of image blocks according to an embodiment of the present disclosure. It should be noted that FIG. 3 is only illustrated as a specific example of a method for displaying a plurality of image blocks and not used to limit the scope of the present disclosure.

As shown in FIG. 3, the time duration for displaying the three-dimensional image P can include multiple cycles, and the processing module 20 controls the plurality of three-dimensional display assemblies 12 to display different image blocks P₁˜Pₙ at different time points t₁˜tₙ in each of the displaying cycles T according to a display order.

As shown in FIG. 3, the displaying cycle T represents the total time duration for displaying a series of image blocks P₁˜Pₙ. It should be noted that in the present disclosure, the displaying cycle T is no longer than a response time of visual persistence of human eyes. In an embodiment, the displaying cycle T is no longer than 0.1 second. Therefore, after displaying all the image blocks P₁˜Pₙ multiple times, based on the persistence of vision of human eyes, the viewer can observe the three-dimensional image P constituted by these image blocks P₁˜Pₙ.

Therefore, in each of the displaying cycle T, the plurality of image blocks P₁˜Pₙ are displayed in the three-dimensional space along the optical axis of the variable focus lens units 121 (the Z direction) at different time points t₁˜tₙ. However, in other embodiments, in each of the displaying cycle T, the plurality of image blocks P₁˜Pₙ can be displayed from top to bottom sequentially or be displayed randomly. In other words, the displaying order of the plurality of image blocks P₁˜Pₙ is not limited in the present disclosure as long as the displaying cycle T is no longer than the response time of visual persistence of human eyes.

In addition, the time interval of each of the image blocks Pₙ being displayed can be defined as the display time Tₙ. In other words, if the display time of the image block P₁ is T₁, then T₁=t₂−t₁, in which t₁ represents the initial time point at which the image block P₁ starts to be displayed, and t₂ represents the end time point at which the image block P₁ stops to be displayed.

In another embodiment, if the three-dimensional display assemblies 12 for displaying the two image blocks P₂ and P₁ are not the same, a plurality of image blocks can be displayed at a same time point.

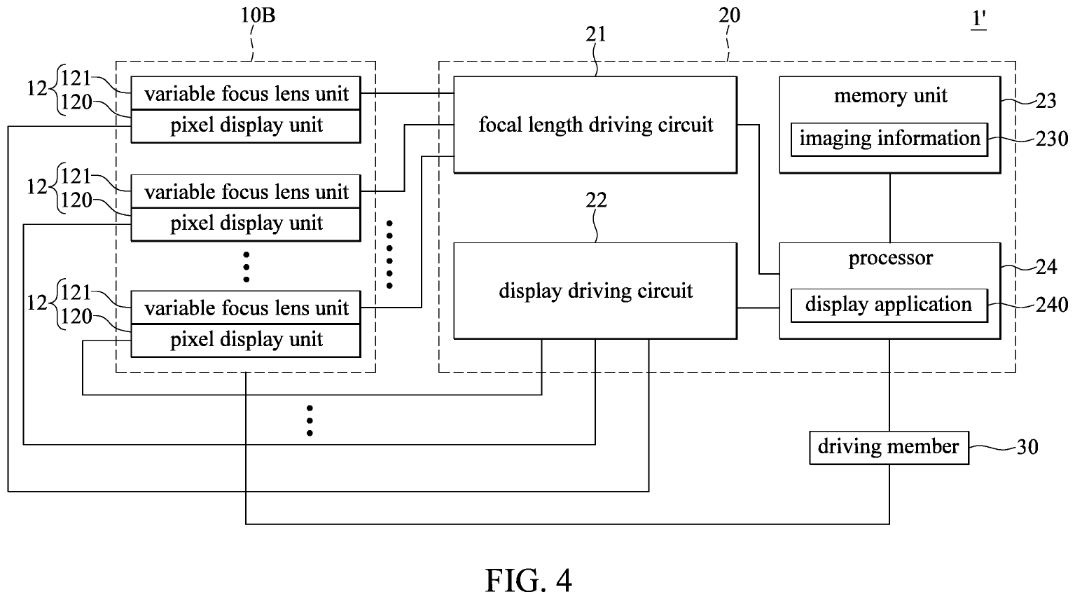

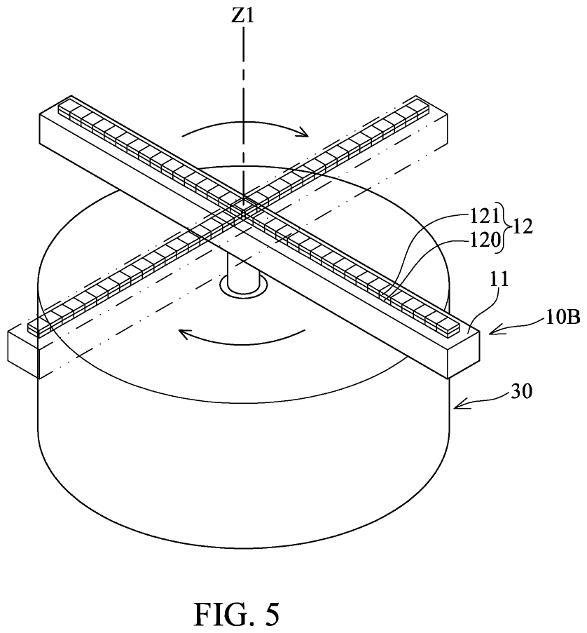

Reference is made to FIG. 4 and FIG. 5. FIG. 4 is a functional block diagram of a three-dimensional display apparatus according to another embodiment of the present disclosure. FIG. 5 is a perspective schematic view showing the cooperation of the image display module and the driving member according to another embodiment of the present disclosure. The elements of the present embodiments that are same as that of the previous embodiments will have the same reference numerals and are not described again herein.

As shown in FIG. 4 and FIG. 5, the difference between the present embodiment and the previous embodiment is that the three-dimensional display assembly 1′ further includes a driving member 30 connected to the substrate 11, and the processing module 20 is electrically connected to the driving member 30. The processing module 20 controls the driving member 30 according to a moving mode so that the substrate 11 is driven to move together with the plurality of three-dimensional display assemblies 12 thereon during a moving cycle.

The driving member 30 can be, for example, a linear motor or a rotating motor, and the moving cycle can be a periodically rotating mode or a periodically linear moving mode. Specifically, as shown in FIG. 4, the processor 24 is electrically connected to the driving member 30. Upon receiving a command, the processor 34 outputs a pulse signal to the driving member 30 through the display application 240 stored therein for controlling the image displaying module 10B to move back and forth linearly or rotate periodically.

As shown in FIG. 5, in the present embodiment, the moving mode is a periodically rotating mode. The processing module 20 drives the substrate 11 together with the plurality of three-dimensional display assemblies 12 to rotate periodically relative to a rotating axis Z1 through the driving member 30. In addition, the rotating axis Z1 is parallel to the optical axis of the variable focus lens units 121.

In addition, the processing module 20 controls the rotating speed of the image display module 10B through the driving member 30 so that the moving cycle of the image display module 10B, i.e., the time required for completing one rotation of the image display module, is shorter than a display time Tₙ of each of the image blocks Pₙ.

Reference is made to FIG. 3 again. For example, if the display time of an image block Pₙ is Tₙ, and the moving cycle of the image display module 10B is S, Tₙ and S satisfy the relationship: Tₙ>S. In an embodiment, a display time Tₙ corresponds to a plurality of the moving cycles S, i.e., Tₙ=mS, in which m is an integral larger than 1.

When the substrate 11 moves together with the plurality of three-dimensional display assemblies 12, the processing module 20 controls each of the variable focus lens units 121 according to the imaging information 230 so that the focus locations of the variable focus lens units 120 are the same at each of the time points during one moving cycle S. In addition, the processing module 20 further controls each of the pixel display units 120 according to the imaging information 230 to output corresponding optical signal at each of the time points in one moving cycle S. Therefore, when the image display module 10B is rotated periodically m times, an image block Pₙ can be observed by a viewer based on visual persistence.

By controlling the focal lengths of the plurality of variable focus lens units 121 corresponding to the image blocks Pₙ and the optical signals Lₙ of the plurality of pixel display units 120, the plurality of image blocks P₁˜Pₙ can be displayed in the three-dimensional space from top to bottom along the optical axis of the variable focus lens units 121 (the Z direction) at different time points t₁-tₙ in each of the displaying cycles T. A three-dimensional image P can be observed by the viewer based on visual persistence of human eyes.

In addition, the plurality of three-dimensional display assemblies 12 is arranged into a strip-like array on the substrate 11. In the present embodiment, the substrate 11 is a strip-like substrate and the plurality of three-dimensional display assemblies 12 is arranged along a long axis direction of the strip-like substrate. However, in other embodiments, the substrate 11 can have the same shape as that shown in FIG. 2 and the plurality of three-dimensional display assemblies 12 are arranged into a strip-like array or a one-dimensional array on the substrate 11. The number of rows of the strip-like array is different from the number of columns of the strip-like array. To be specific, the strip-like array is not limited to one having single row or single column.

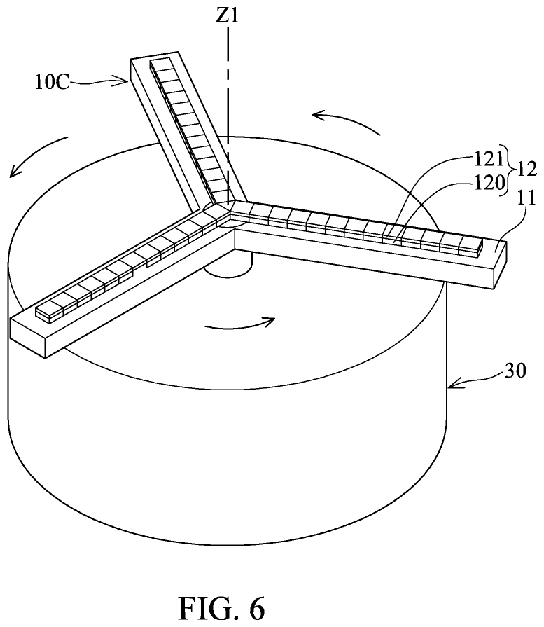

Reference is made to FIG. 6. FIG. 6 is a perspective schematic view showing the cooperation of the image display module and the driving member according to yet another embodiment of the present disclosure. In the image display module 10C of the present embodiment, the plurality of three-dimensional display assemblies 12 is radially arranged in rows around the rotating axis Z1.

Similar to the previous embodiment, the moving mode in the present embodiment is a periodically rotating mode. The processing module 20 can drive the substrate 11 and the plurality of three-dimensional display assemblies 12 thereon, through the driving member 30, to periodically rotate around the rotating axis Z1.

Specifically, the processor 24 of the processing module 20 can have another display application 240 corresponding to the image display module 10C pre-stored therein. By executing the display application 240 built therein, the processor 24 can output a pulse signal to the driving member 30 for controlling the moving cycle S′ of the image display module 10C. In the present embodiment, the moving cycle S′ of the three-dimensional display module 10C is also no longer than the display time Tₙ of any one of the image blocks Pₙ.

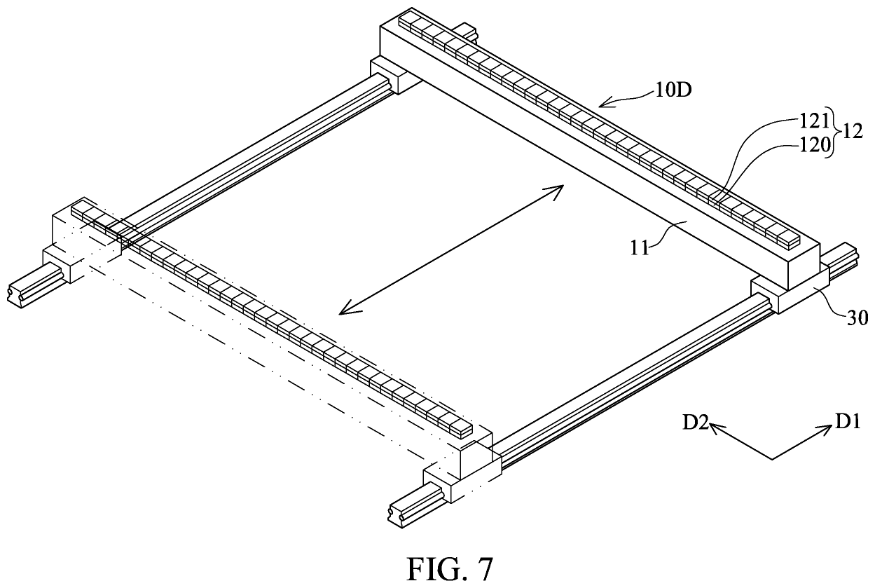

Reference is made to FIG. 7. FIG. 7 is a perspective schematic view showing the cooperation of the image display module and the driving member according to a further embodiment of the present disclosure. In the present embodiment, the moving mode is a periodically linear moving mode. The processing module 20 drives the substrate 11 together with the plurality of three-dimensional display assemblies 12, through the driving member 30, to move along a first direction D1 back and forth. In the present embodiment, the processing module drives the image display module 10D to move back and forth along a slide through the driving member 30. However, the present disclosure is not limited thereto.

The processor 24 of the processing module 20 can have another display application 240 corresponding to the image display module 10D pre-stored therein. The processor 4 can output a pulse signal to the driving member 30 through the display application 240 stored therein for controlling the moving cycle S″ of the image display module 10D. In the present embodiment, the moving cycle S″ of the image display module 10D represents the time required for moving the image display module 10D back and forth for a single time. In addition, the moving cycle S″ will also be no longer than the display time Tₙ of any one of the block image Pₙ.

In the present embodiment, the plurality of three-dimensional display assemblies 12 is arranged into a strip-like array along a second direction different from the first direction on the substrate 11.

When the substrate 11 moves together with the plurality of three-dimensional display assemblies 12, the processing module 20 controls the variable focus lens units 121 corresponding to the image blocks Pₙ according to the imaging information for rendering the focus position of each of the variable focus lens units 121 the same at each time point during the moving cycle S″. In addition, the processing module 20 further controls the pixel display units 120 corresponding to the image blocks Pₙ according to the imaging information 230 for outputting the corresponding optical signals at each time point during the moving cycle S″. Therefore, when the image display module 10D is moved m times periodically, the viewer can observe one of the image blocks Pₙ based on the visual persistence of human eyes.

Subsequently, by controlling the focal lengths of the plurality of variable focus lens units 121 and the optical signals Ln of the plurality of pixel display units 120, the plurality of image blocks P₁˜Pₙ can be displayed in the three-dimensional space from bottom to top along the optical axis of the variable focus lens units 121 (the Z direction) at different time points t₁˜tₙ in each displaying cycle. The viewer can observe the three-dimensional image P based on the visual persistence of human eyes.

Therefore, in the embodiments shown in FIG. 5 to FIG. 7, a one-dimensional image can be transformed into a three-dimensional image by adjusting the focal lengths of the variable focus lens units 121 and the optical singles Ln of the pixel display units 120 at different time points, moving the image display modules 10B˜10D, and utilizing the visual persistence of human eye.

In conclusion, one of the advantages of the present disclosure is that the three-dimensional image display apparatus 1, 1′ provided by the present disclosure can generate a three-dimensional image P that is suitable for multiple viewers at various angles by the technical feature of “the processing module 20 controlling the optical signal outputted by each of the pixel display units 120 at different time points, and adjusting the focal positions of each of the variable focus lens units 121 for periodically displaying a plurality of image blocks P₁˜Pₙ corresponding to a three-dimensional image during a time duration, and a displaying cycle T of displaying the plurality of image blocks P₁˜Pₙ is no longer than a response time of visual persistence of human eyes”.

In addition, the plurality of three-dimensional display assemblies 12 of the image display modules 10B˜10D can be arranged into a strip-like array. The processing module 20 can control the motion (including moving back and forth or rotating) of the display modules 10B˜10D through the driving unit 30 in a moving cycle. Therefore, the three-dimensional image P can be observed by the viewer based on the visual persistence of human eyes. Accordingly, a three-dimensional image can be produced by less three-dimensional assemblies 12, thereby reducing the costs associated therewith.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A three-dimensional image display apparatus, including:
an image display module including a plurality of three-dimensional display assemblies, each of the three-dimensional display assemblies including:
a pixel display unit for outputting an optical signal; and
a variable focus lens unit disposed on the pixel display unit, the optical signal passing through the variable focus lens unit and being projected to a focal position of the variable focus lens unit; and
a processing module electrically connected to the image display module, wherein when the processing module receives a command, the processing module controls the optical signal outputted by each of the pixel display units and adjusts a focal length of each of the variable focus lens units according to an imaging information for periodically displaying a plurality of image blocks corresponding to a three-dimensional image during a time duration, and a displaying cycle of displaying the plurality of image blocks is not longer than a response time of visual persistence of human eyes.

2. The three-dimensional image display apparatus according to claim 1, wherein the processing module controls each of the three-dimensional display assemblies to display the plurality of image blocks in a display order within each displaying cycle.

3. The three-dimensional image display apparatus according to claim 1, wherein the processing module controls each of the three-dimensional display assemblies to sequentially display the plurality of image blocks along an optical axis of the variable focus lens unit within each displaying cycle.

4. The three-dimensional image display apparatus according to claim 1, wherein the image display module further includes a substrate, and the plurality of three-dimensional display assemblies is disposed on the substrate.

5. The three-dimensional image display apparatus according to claim 4, further including a driving member connected to the substrate, wherein the processing module is electrically connected to the driving member and controls the driving member according to a moving mode so that the substrate is driven to move together with the plurality of three-dimensional display assemblies on the substrate during a moving cycle.

6. The three-dimensional image display apparatus according to claim 5, wherein the moving cycle is shorter than a display time of each of the image blocks, and the display time corresponds to a plurality of the moving cycles.

7. The three-dimensional image display apparatus according to claim 5, wherein when the substrate and the plurality of three-dimensional display assemblies thereon are moving, the processing module controls each of the pixel display units according to the imaging information to output the optical signal corresponding to each time point in the moving cycle.

8. The three-dimensional image display apparatus according to claim 7, wherein when the substrate and the plurality of three-dimensional display assemblies thereon are moving, the processing module further controls each of the variable focus lens unit according to the imaging information for rendering the focus position of each of the variable focus lens units the same at each time point in the moving cycle.

9. The three-dimensional image display apparatus according to claim 5, wherein the moving mode is a periodical rotating mode, and the processing module drives the substrate and the plurality of three-dimensional display assemblies thereon, through the driving member, to periodically rotate around a rotating axis of the image display module.

10. The three-dimensional image display apparatus according to claim 9, wherein the plurality of three-dimensional display assemblies is radially arranged in rows around the rotating axis.

11. The three-dimensional image display apparatus according to claim 5, wherein the moving mode is a periodical linear moving mode, and the processing module drives the substrate and the plurality of three-dimensional display assemblies thereon, through the driving member, to periodically move back and forth along a first direction.

12. The three-dimensional image display apparatus according to claim 11, wherein the plurality of three-dimensional display assemblies on the substrate is arranged into a one-dimensional array along a second direction that extends in a different direction from the first direction.

13. The three-dimensional image display apparatus according to claim 5, wherein the plurality of three-dimensional display assemblies on the substrate is arranged into a strip-like array.

14. A three-dimensional image display apparatus, including:
an image display module including a plurality of three-dimensional display assemblies, each of the three-dimensional display assemblies including:
a pixel display unit for outputting an optical signal; and
a variable focus lens unit disposed on the pixel display unit, the optical signal passing through the variable focus lens unit and being projected at a predetermined position; and
a processing module electrically connected to the image display module, the processing module being configured to control the optical signal and the predetermined position where the optical signal is projected;
wherein the processing module has an imaging information stored therein, the imaging information including a plurality of image blocks corresponding to a three-dimensional image, a display order of the plurality of image blocks, an address of at least one of the three-dimensional display assemblies for displaying each of the image blocks, and the optical signal and a focal length driving signal of the at least one of the plurality of three-dimensional display assemblies for displaying each of the image blocks;
wherein when the processing module receives a command, the processing module controls the optical signal and a focal length driving signal outputted by each of the three-dimensional display assemblies according to the imaging information for displaying the plurality of image blocks in the display order during a time duration, thereby forming the three-dimensional image corresponding to a three-dimensional object.
